(19) United States
(12) Patent Application Publication
(10) Pub. No.: US 2025/0155278 A1
(43) Pub. Date: May 15, 2025

(54) SYSTEM AND METHOD FOR RAYLEIGH-BASED DISTRIBUTED ACOUSTING SENSING

(71) Applicant: PRYSMIAN S.p.A., Milano (IT)

(72) Inventors: Riccardo VERONESE, Selvazzano Dentro (IT); Luca PALMIERI, Camponogara (IT)

(21) Appl. No.: 18/942,001

(22) Filed: Nov. 8, 2024

(30) Foreign Application Priority Data
Nov. 9, 2023 (IT) 102023000023607

(51) Int. Cl. G01H 9/00; G01D 5/353

(52) U.S. Cl. CPC G01H 9/004; G01D 5/35361

(57) ABSTRACT

A system for Rayleigh-based distributed acoustic sensing. A laser source injects in an optical fiber a probe light signal periodically modulated with a modulation frequency ƒₘ; the probe light signal and the response light signal emitted by the optical fiber in response to the probe light signal undergoing Rayleigh backscattering are subjected to coherent detection, thereby providing respective probe and response electrical signals; these are sampled with a sampling frequency ƒₛ=M ƒₘ, M being a positive integer, thereby providing probe and response sampled signals; in these sampled signal, respective arrays of N consecutive probe and response samples are identified, with N=G·M, G being a positive integer; a Rayleigh response of the optical fiber is provided based on the arrays of probe and response samples; and information indicative of the acoustic event are obtained by processing the Rayleigh response of the optical fiber.

### BACKGROUND

The present disclosure relates to distributed sensing in optical fibers. In particular, the present disclosure relates to a system and method for Rayleigh-based distributed acoustic sensing.

### RELATED ART

It is known use of optical fibers as sensors for a variety of physical parameters, such as pressure or temperature. Furthermore, use of optical fibers enables the so-called “distributed fiber optic sensing” (DFOS), in which the physical parameter to be sensed can be continuously sensed along the fiber length.

A known scheme typically used for DFOS is the so-called “single-ended” scheme, schematically depicted in FIG. 1. According to the known single-ended scheme, one end of an optical fiber 1 having a transmission property susceptible to the physical parameter to be sensed is connected to an interrogator device 2. The interrogator device 2 sends a probe light signal into the optical fiber 1 and detects the corresponding response light signal transmitted back by the optical fiber 1 in response thereto. The interrogator device 2 then processes the response light signal, thereby extracting information indicative of the physical parameter to be sensed.

One specific application of DFOS is distributed acoustic sensing (DAS). DAS enables detection and localization of “acoustic events” happening in a specific position and time along a structure to be monitored.

Typically, DAS is based on an analysis of the response light signal which is generated by the optical fiber when the probe light signal propagating therethrough undergoes a linear, elastic backscattering, e.g., Rayleigh backscattering.

Rayleigh-based DAS (RDAS) may be implemented based on several known techniques, usually known as “reflectometric techniques”. Known reflectometric techniques can be divided into two main categories, according to the nature of the probe light signal exploited.

A first category of reflectometric techniques employs pulse-shaped probe light signals. More specifically, in pulse-based reflectometric techniques (such as OTDR, namely Optical Time Domain Reflectometer), a sequence of light pulses is injected in the optical fiber, and one measurement of the response light signal is performed per each injected light pulse.

A second category of reflectometric techniques instead makes use of non-pulse-shaped probe light signals. In non-pulse-based reflectometric techniques (such as OFDR, namely Optical Frequency Domain Reflectometer), the probe light signal typically is a continuous wave whose instantaneous frequency is periodically linearly swept in time, the linearity of the sweep being a requirement for the technique to be effective. For each period of the frequency linear sweep, one measurement of the response light signal is typically performed.

### SUMMARY

In the present description and in the claims, the expression “acoustic event” will designate a pressure change causing a localized strain (e.g., an axial strain) of the sensing optical fiber deployed along the structure to be monitored. The acoustic event may be a vibration, namely a periodic pressure change causing a localized strain of the sensing optical fiber which periodically varies over time.

The Applicant has noticed that the above known reflectometric techniques for RDAS exhibit some drawbacks.

In both the above known reflectometric techniques, indeed, the response light signal of the optical fiber is measured at discrete time instants equally spaced by a measurement period δtᵣ. According to the Nyquist-Shannon sampling theorem, the measurement period δtᵣ between consecutive measurements sets an upper limit on the maximum detectable acoustic frequency as ƒₐ ≤ƒᵣ/2=1/(2δtᵣ), where ƒᵣ=1/δtᵣ is the measurement rate (in Hz). In the following description, the maximum detectable acoustic frequency will be also termed “acoustic bandwidth”.

As far as pulse-based reflectometric techniques are concerned, for the reflectometric technique to be effective, consecutive light pulses shall be time spaced by at least one round-trip propagation time through a target sensing range Lₘₐₓ, which is referred to as the maximum length of the optical fiber that can be interrogated. This sets a lower limit on the measurement period δtᵣ namely δtᵣ≥2Lₘₐₓ/c, where c is the propagation speed of light within the optical fiber. Therefore, the maximum detectable acoustic frequency scales with the target sensing range Lₘₐₓ according to the following equation: ƒₐ ≤c/(4Lₘₐₓ). The longer the target sensing range Lₘₐₓ, the lower the maximum detectable acoustic frequency. For example, for Lₘₐₓ=10 km the maximum detectable acoustic frequency is ƒₐ ≤5 kHz, while for Lₘₐₓ=100 km the maximum detectable acoustic frequency ƒₐ ≤500 Hz (assuming c≃2·10⁸ m/s). Another way to look at this limitation entails considering that, as the probe light pulse propagates through the optical fiber, it illuminates only a specific fiber span at a time. Therefore, if an acoustic event happens at a position z in the optical fiber that is not traversed by the probe light pulse during the time extent of the acoustic event, such an acoustic event cannot be detected, leading to the presence of an intrinsic deadtime during which the optical fiber is not monitored.

As to non-pulse-based reflectometric techniques, in this case the limit on the maximum detectable acoustic frequency ƒₐ is determined by two factors. The first one is the maximum temporal rate at which the linear sweep of the instantaneous frequency of the probe light signal can be performed. The second one is the ratio between the period of the vibration to be sensed and the period of the frequency linear sweep. More precisely, the period of the frequency linear sweep shall be shorter than the period of the vibration. On the other hand, for a given target sensing range Lₘₐₓ, reducing the period of the frequency linear sweep corresponds to increasing the electrical bandwidth at detection. Owing to these factors, implementing long-range RDAS with large acoustic bandwidth is rather challenging.

Furthermore, the way in which the linear sweep of the instantaneous frequency of the probe light signal is obtained determines the presence of intrinsic deadtime also in non-pulse-based reflectometric techniques. For example, if a tunable laser source is used to generate the probe light signal, the deadtime corresponds to the “recoiling” phase, during which the tunable laser is brought back to the initial frequency after a linear sweep is completed.

The Applicant has then faced the problem of providing a system and method for Rayleigh-based distributed acoustic sensing which overcome the aforesaid drawbacks.

For example, the Applicant has tackled the problem of providing a system and method for Rayleigh-based distributed acoustic sensing which exhibit substantially no deadtime and a measurement period whose lower limit is substantially independent of the target sensing range Lₘₐₓ.

Without being bound to any theory, the Applicant has noticed that, since Rayleigh backscattering is a linear process, according to the theory of linear systems its input/output relation can be completely described in terms of a transfer function in the spectral domain, or a response function in the time domain. The time-domain response function of the optical fiber will be termed herein after also “Rayleigh response”. Rayleigh-based distributed acoustic sensing may then rely on the analysis of the Rayleigh response of the optical fiber. Since the values of the Rayleigh response are complex, the analysis shall take into account both amplitude and phase of its values. Hence, if a(t) is the probe light signal and b(t) is the response light signal, the relation between the signals a(t) and b(t) in the spectral domain can be written, as:

$$b ( ω ) = H ( ω ) a ( ω ) \qquad [ 1 ]$$

where a(ω)= [symbol] [a(t)] is the spectrum of the probe light signal, b(ω)= [symbol] [b(t)] is the spectrum of the response light signal and H(ω) is the frequency-domain Rayleigh response of the optical fiber, where [symbol] indicates the Fourier transform. From H(ω), the Rayleigh response of the optical fiber can be obtained through an inverse Fourier transform as:

$$h ( t ) = {ℱ}^{- 1} [ H ( ω ) ] = {ℱ}^{- 1} [ b ( ω ) / a ( ω ) ] \qquad [ 2 ]$$

where [symbol] ⁻¹ indicates the inverse Fourier transform. The Rayleigh response may then be converted into a spatial-domain Rayleigh response, through the propagation speed of light in the optical fiber. By proper analysis of the variation of the spatial-domain Rayleigh response over time, information indicative of the acoustic event to be sensed may be obtained.

Starting from the above, the Applicant has realized that equation [2], expressed in the continuous-time domain, still holds if H(ω) is replaced with its frequency-sampled version H(ωₖ), ωₖ=ω₀+2πkƒₘ, k∈K⊂ [symbol] and if the inverse Fourier transform is replaced with an inverse discrete Fourier transform. In this case, a discrete-time signal h[n·dt] is obtained, corresponding to the sampled periodic repetition of the continuous-time function h(t), n being the sample index.

According to the theory of the discrete Fourier transform, the repetition period T will be equal to the reciprocal of the spacing ƒₘ between the frequency-domain samples of H(ωₖ), and the time-domain sampling interval dt will be equal to T/N, N corresponding to the number of samples composing H(ωₖ).

In view of the above, the Applicant has realized that, by providing the probe light signal a(t) in the form of a probe light signal with carrier frequency ω₀, periodically modulated with a modulation period Tₘ=1/ƒₘ (the modulation may be applied to one or more of the probe light signal's quantities, namely amplitude, frequency, and phase), the spectrum of the probe light signal a(ω) has discrete support A={ωₖ=ω₀+2πkƒₘ, k∈K⊂ [symbol] }, in whose points it assumes the values a(ωₖ) [symbol] aₖ, k∈K.

According to the theory of linear systems, when injecting such a probe light signal into an optical fiber, also the spectrum of the corresponding response light signal b(ω) has discrete support A, in whose points it assumes the values bₖ [symbol] b(ωₖ)=H(ωₖ) aₖ, k∈K.

Hence, by subjecting both the light signals a(t) and b(t) to optical coherent detection, a probe electrical signal A(t) and a response electrical signal B(t) are obtained, whose spectra have again discrete support A′, which is substantially rigidly shifted towards baseband relatively to A and whose corresponding values are still aₖ and bₖ (short of a fixed scale factor). The electrical signals A(t) and B(t) may then be sampled with a sampling frequency ƒₛ such that ƒₛ=M ƒₘ, where M is a non-zero positive integer such that ƒₛ≥2 maxA′, maxA′ being the maximum value in A′, thereby obtaining a probe sampled signal a[n·dt] and a response sampled signal b[n·dt], where dt=1/ƒₛ and n is the sample index.

A point-wise ratio according to the right-hand side of equation [2] between the discrete Fourier transforms of the sampled signals a[n·dt] and b[n·dt] shall provide the frequency response coefficients H(ωₖ), as long as the points of A′ are contained in the set of discrete frequencies over which the spectra of a[n·dt] and b[n·dt] are sampled by the discrete Fourier transform.

In this respect, the Applicant has noticed that such condition is fulfilled when T=Q·1/ƒₘ, where Q is a non-zero positive integer. In other words, the discrete Fourier transform of the sampled signals a[n·dt] and b[n·dt] over arrays of N=G ƒₛ/ƒₘ=G·M samples is computed, where G is a non-zero positive integer. The arrays identified in the probe sampled signal a[n·dt] and in the response sampled signal b[n·dt] respectively are a=[aᵤ, . . . , a_{u+N-1}] and b=[bᵥ, . . . , b_{v+N-1}], where u corresponds to the starting index from which samples of a[n·dt] are taken and v is the starting index from which samples of b[n·dt] are taken. The two arrays may be time misaligned, meaning that the starting indexes u and v may have different values. Their discrete Fourier transform provides two arrays â=[â₀, . . . , â_{N-1}] and \hat{b}=[\hat{b}₀, . . . , \hat{b}_{N-1}], respectively. The arrays â=[â₀, . . . , â_{N-1}] and \hat{b}=[\hat{b}₀, . . . , \hat{b}_{N-1}] may then be restricted to those samples corresponding to values contained in A′ and subjected to a point-wise ratio according to the right-hand side of equation [2] above.

After the point-wise ratio has been performed, an inverse Fourier transform is applied to the result, thereby obtaining a discrete Rayleigh response h[m·dt] of the optical fiber. The discrete Rayleigh response h[m·dt] may then be converted into a discrete spatial-domain Rayleigh response h[m·dz], whose spatial sampling step dz is provided by the following equation:

$$dz = \frac{{c}_{0}}{2 ( \vert {A}^{′} \vert - 1 ) {f}_{m} {n}_{g}} \qquad [ 3 ]$$

where c₀ is the propagation speed of light in vacuum, n_{g} is the group refractive index in the optical fiber, |A′| is the cardinality of the discrete support A′ of the spectra of the electrical signals A(t) and B(t), and the factor 2 accounts for the round-trip propagation of the probe light signal through the optical fiber.

The above discussion is still valid if arrays â and \hat{b} are restricted to samples pertaining to a subset A″ of the discrete support A′.

The measurement of the Rayleigh response may be iterated at discrete time instants, thereby providing a sequence of measurements of the spatial-domain Rayleigh response h[m·dz] equally spaced in time by the iteration period, which basically represents the measurement period δtᵣ. Specifically, a new iteration may be performed by incrementing the values of the starting indexes u and v of the same positive integer amount q≥1, as long as samples of the electrical signals A(t) and B(t) are available. The measurement period δtᵣ is then related to the sampling period dt according to the following equation δtᵣ=δt·q. The lower limit of the measurement period δtᵣ is then δtᵣ=δt, which is obtained when q=1, namely when the measurement of the Rayleigh response is repeated each time a new sample of both the probe electrical signal A(t) and the response electrical signal B(t) is available.

Therefore, the lower limit of the measurement period δtᵣ is substantially independent of the target sensing range Lₘₐₓ.

The target sensing range Lₘₐₓ indeed affects the modulation frequency ƒₘ of the probe light signal, which shall be set such that Lₘₐₓ=c/2ƒₘ. However, as said above, the minimum measurement period δtᵣ of the Rayleigh response is equal to the sampling period dt, which not only is a function of the modulation frequency ƒₘ (and hence of Lₘₐₓ), but is also inversely proportional to the integer number M. Hence, in principle, by setting a suitably high value of M, the lower limit of the measurement period δtᵣ may be arbitrarily reduced. From the practical point of view, this means that the lower limit of the measurement period δtᵣ is substantially due to the processing capabilities of the data processing unit implementing the sampling and the processing of the electrical signals provided by the optical coherent detection of the probe light signal and response light signal.

The result of the procedure above, e.g., the sequence of measurements of the spatial-domain Rayleigh response h[m·dz] equally spaced in time by the iteration period, is then processed to obtain information indicative of the acoustic event. For this purpose, known algorithms can be applied, e.g., spectral correlation analysis or direct phase demodulation.

Therefore, according to a first aspect, the present disclosure provides a system for Rayleigh-based distributed acoustic sensing of an acoustic event, the system comprising:
an optical fiber;
a laser source configured to inject a probe light signal a(t) in the optical fiber, the probe light signal a(t) being periodically modulated with a modulation frequency ƒₘ;
a first optical detector configured to perform a coherent detection of the probe light signal a(t) as injected in the optical fiber, thereby providing a probe electrical signal A(t), and a second optical detector configured to perform a coherent detection of a response light signal b(t) emitted by the optical fiber in response to the probe light signal a(t) undergoing Rayleigh backscattering through the optical fiber, thereby providing a response electrical signal B(t); and
a data processing unit configured to sample the probe electrical signal A(t) and the response electrical signal B(t) with a sampling frequency ƒₛ such that ƒₛ=M ƒₘ where M is a non-zero positive integer, thereby providing a probe sampled signal a[n·dt] and a response sampled signal b[n·dt]; identify in the probe sampled signal a[n·dt] and the response sampled signal b[n·dt] a first array of N consecutive probe samples and a second array of N consecutive response samples, respectively, with N=G·M, G being a non-zero positive integer; provide a Rayleigh response of the optical fiber based on the first array of N consecutive probe samples and the second array of consecutive N response samples; and obtain information indicative of the acoustic event by processing the Rayleigh response of the optical fiber.

According to some embodiments, the periodically modulated probe light signal a(t) is a non-pulsed shaped light signal, where “non-pulsed shaped light signal” means that the amplitude of the light signal may vanish only in a discrete set of time instants.

According to an embodiment:
the laser source is further configured to provide the first optical detector and the second optical detector with an unmodulated light signal c(t), the unmodulated light signal c(t) having a carrier frequency shifted relative to a carrier frequency of the probe light signal a(t); and
the first optical detector and second optical detector are configured to perform a heterodyne coherent detection of the probe light signal a(t) and the response light signal b(t), respectively, using the unmodulated light signal c(t).

According to an embodiment, the system further comprises two polarization controllers configured to bring the unmodulated light signal c(t) on respective mutually orthogonal polarizations states, and the second optical detector comprises two optical detectors, each one operating on a respective polarization state.

According to an embodiment, the system further comprises an optical amplifier configured to increase the optical power of the probe light signal a(t) before it is injected in the optical fiber.

In addition or alternatively, the system further comprises a further optical amplifier configured to increases the optical power of the response light signal b(t) before it is received by the second optical detector.

According to a second aspect, the present disclosure provides a method for Rayleigh-based distributed acoustic sensing of an acoustic event, the method comprising:
(a) injecting a probe light signal a(t) in an optical fiber, the probe light signal a(t) being periodically modulated with a modulation frequency ƒₘ;
(b) performing a coherent detection of the probe light signal a(t) as injected in the optical fiber, thereby providing a probe electrical signal A(t);
(c) performing a coherent detection of a response light signal b(t) emitted by the optical fiber in response to the probe light signal a(t) undergoing Rayleigh backscattering through the optical fiber, thereby providing a response electrical signal B(t);
(d) sampling the probe electrical signal A(t) and the response electrical signal B(t) with a sampling frequency ƒₛ such that ƒₛ=M ƒₘ where M is a non-zero positive integer, thereby providing a probe sampled signal a[n·dt] and a response sampled signal b[n·dt];
(e) identifying in the probe sampled signal a[n·dt] and the response sampled signal b[n·dt] a first array of N consecutive probe samples and a second array of N consecutive response samples, respectively, with N=G·M, G being a non-zero positive integer;
(f) providing a Rayleigh response of the optical fiber based on the first array of N consecutive probe samples and the second array of consecutive N response samples; and
(g) obtaining information indicative of the acoustic event by processing the Rayleigh response of the optical fiber.

According to an embodiment, step (d) comprises sampling the probe electrical signal A(t) and the response electrical signal B(t) synchronously.

According to an embodiment, step (e) comprises identifying the first array of N consecutive probe samples and the second array of N consecutive response samples in a time-misaligned way.

According to an embodiment, step (f) comprises:
applying a discrete-time Fourier transform to the first array of N consecutive probe samples and to the second array of N consecutive response samples, thereby obtaining arrays â=[â₀, . . . , â_{N-1}] and \hat{b}=[\hat{b}₀, . . . , \hat{b}_{N-1}], respectively;
subjecting the arrays â=[â₀, . . . , â_{N-1}] and \hat{b}=[\hat{b}₀, . . . , \hat{b}_{N-1}] to a point-wise ratio, thereby obtaining a further array ĉ; and
applying an inverse discrete-time Fourier transform to the further array ĉ.

According to an embodiment, subjecting the arrays â=[â₀, . . . , â_{N-1}] and \hat{b}=[\hat{b}₀, . . . , \hat{b}_{N-1}] to the point-wise ratio comprises:
constructing two restricted arrays â′ and \hat{b}′ by restricting each one of the arrays â=[â₀, . . . , â_{N-1}] and \hat{b}=[\hat{b}₀, . . . , \hat{b}_{N-1}] to frequency values contained in their discrete frequency-domain support; and
obtaining the further array ĉ as ĉ=\hat{b}′∅â′ where ∅ stands for Hadamard division.

According to an embodiment, step (g) comprises determining a spatial-domain Rayleigh response h[m·dz] of the optical fiber and obtaining the information indicative of the acoustic event based on the spatial-domain Rayleigh response h[m·dz].

According to an embodiment, steps (d) to (g) are periodically iterated at discrete time instants, thereby providing a sequence of spatial-domain Rayleigh responses h[m·dz] equally spaced in time.

According to an embodiment, the method further comprises applying a spectral correlation analysis to at least two spatial-domain Rayleigh responses h[m·dz] measured at different times t₁ and t₂.

For the purpose of the present description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

For the purpose of the present description and of the appended claims, the words “a” or “an” should be read to include one or at least one and the singular also includes the plural unless it is obvious that it is meant otherwise. This is done merely for convenience and to give a general sense of the disclosure.

The present disclosure, in at least one of the aforementioned aspects, can be implemented according to one or more of the present embodiments, in some implementations combined together.

### BRIEF DESCRIPTION OF DRAWINGS

The present disclosure will provide further particulars in the following detailed description, given by way of example and not of limitation, with reference to the following drawings, wherein:

FIG. 1 (already described above) shows a known single-ended scheme typically used for DFOS;

FIG. 2 schematically shows a system for Rayleigh-based distributed acoustic sensing according to embodiments of the present invention;

FIG. 3 is a flow chart of the operation of the data processing unit included in the system of FIG. 2, according to embodiments of the present invention;

FIGS. 4A-4D show the interrogator device according to four possible variants of the present invention;

FIG. 5 shows in further detail the structure of the laser source according to an embodiment of the present invention;

FIG. 6 is a graph showing experimental results of a single measurement of the Rayleigh response provided by a system according to embodiments of the present invention;

FIG. 7 is a more detailed flow chart of the step of providing information indicative of the acoustic event to be sensed based on the Rayleigh response;

FIG. 8 is a graph showing experimentally obtained information indicative of an impulsive acoustic event; and

FIG. 9 is a graph showing experimentally obtained information indicative of a periodic acoustic event (vibration).

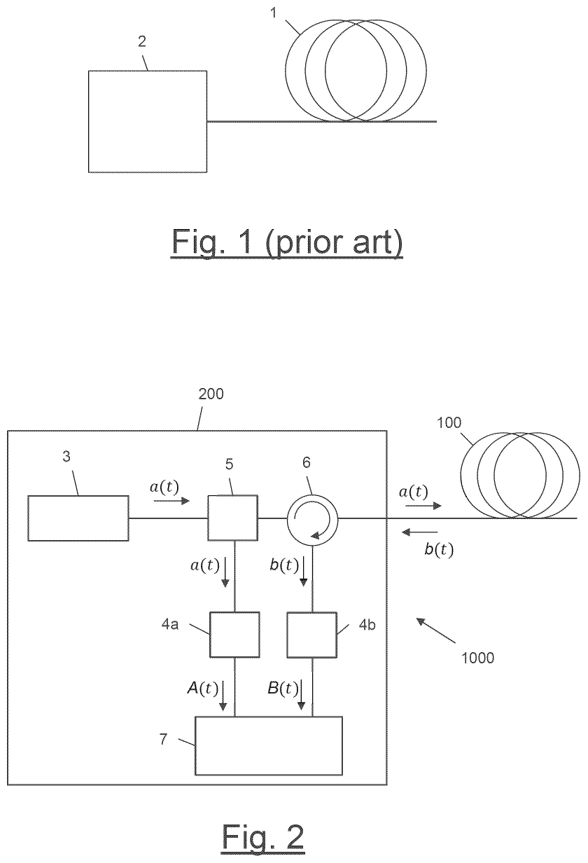

### DETAILED DESCRIPTION

FIG. 2 shows a system 1000 for Rayleigh-based distributed acoustic sensing according to embodiments of the present invention.

The system 1000 comprises an optical fiber 100 and an interrogator device 200 connected to one end of the optical fiber 100 according to a single-ended scheme.

The optical fiber 100 is deployed along a structure to be monitored (not depicted in FIG. 2) and has transmission properties susceptible to variations of the strain induced by possible acoustic events (either impulsive events or vibrations) affecting the structure to be monitored. The Applicant has made positive tests using a single mode ITU-T G.652 optical fiber. The length of the optical fiber 100 may be up to 50-100 km, as an example.

The interrogator device 200 comprises a laser source 3 configured to generate a probe light signal a(t) and inject it into the optical fiber 100. The probe light signal a(t) is a light signal with carrier frequency ω₀, periodically modulated with a modulation frequency ƒₘ. The probe light signal a(t) thus has a discrete frequency-domain support A={ωₖ=ω₀+2πkƒₘ, k∈K⊂ [symbol] }. The modulation may be applied to one or more of the probe light signal's quantities, namely amplitude, frequency, and phase. The modulation may be a non-linear modulation. The periodically modulated probe light signal a(t) may be a non-pulsed shaped light signal, where “non-pulsed shaped light signal” means that the amplitude of the light signal may vanish only in a discrete set of time instants. The modulation frequency ƒₘ may be set according to the desired target sensing range Lₘₐₓ. Specifically, modulation frequency ƒₘ may be set such that Lₘₐₓ=c/2ƒₘ. The carrier frequency ω₀ of the probe light signal a(t) may be selected within a frequency range in which the optical fiber 100 is single mode. For example, the laser source 3 has a coherence length equal to at least 2·Lₘₐₓ.

The interrogator device 200 also comprises two optical detectors 4a 4b. Each optical detector 4a, 4b is configured to perform a coherent detection of a respective light signal. For example, the optical detector 4a is configured to perform a coherent detection of the probe light signal a(t) as injected in the optical fiber 100, while the optical detector 4b is configured to perform a coherent detection of the response light signal b(t) emitted by the optical fiber 100 in response to the probe light signal a(t) undergoing Rayleigh backscattering through the optical fiber 100. Coherent detections of the probe light signal a(t) and response light signal b(t) result in a probe electrical signal A(t) and a response electrical signal B(t), respectively; both the electrical signals A(t) and B(t) have a discrete frequency-domain support A′={ω′ₖ=2πƒᵢₙₜ+2πkƒₘ, k∈K⊂ [symbol] }, where ƒᵢₙₜ is an intermediate frequency such that ƒᵢₙₜ≥|minK|ƒₘ.

In order to enable detection of both the probe light signal a(t) and the response light signal b(t), according to an embodiment the interrogator device 200 comprises an optical splitter 5 and an optical circulator 6.

The optical splitter 5 has an input connected to the output of the laser source 3 and two outputs connected to the optical detector 4a and to one of the ports of the optical circulator 6, respectively. Two further ports of the optical circulator 6 are connected to the optical fiber 100 and to the optical detector 4b, respectively. This way, the probe light signal a(t) is split into two portions: one portion is sent to the optical detector 4a, while the other portion is sent to the optical fibre 100 via the optical circulator 6. Besides, the response light signal b(t) provided by the optical fiber 100 is sent via the circulator 6 to the optical detector 4b. The optical splitter 5 may have a splitting ratio comprised between 85:15 and 95:5, for example 90:10, the major part of the probe light signal a(t) being directed towards the optical fiber 100 via the optical circulator 6.

The interrogator device 200 also comprises a data processing unit 7 cooperating with the optical detectors 4a, 4b. The data processing unit 7 is configured to process the probe electrical signal A(t) and the response electrical signal B(t) to provide information indicative of the acoustic event to be sensed.

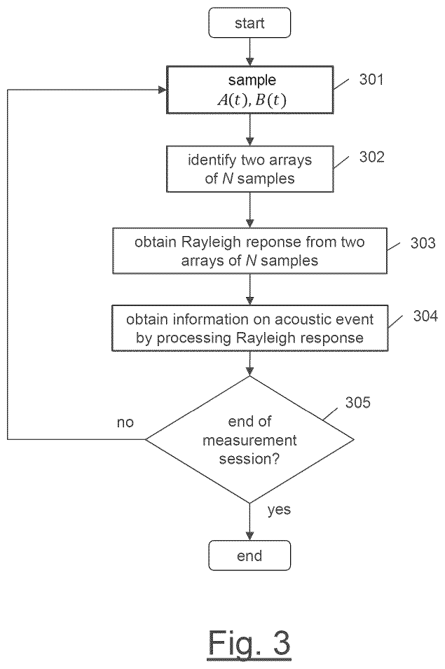

The operation of the data processing unit 7 will be now described in detail with reference to the flow chart of FIG. 3.

According to an embodiment, the data processing unit 7 samples the probe electrical signal A(t) and the response electrical signal B(t) (step 301). For both the electrical signals A(t) and B(t), the sampling is performed with a sampling frequency ƒₛ such that ƒₛ=M ƒₘ where M is a non-zero positive integer such that ƒₛ=M ƒₘ≥2 maxA′, thereby obtaining a probe sampled signal a[n·dt] and a response sampled signal b[n·dt], where dt=1/ƒₛ is the sampling period and n is the sample index. The probe electrical signal A(t) and the response electrical signal B(t) may be synchronously sampled.

Then, according to an embodiment the data processing unit 7 identifies in the probe sampled signal a[n·dt] and in the response sampled signal b[n·dt] a first array a=[aᵤ, . . . , a_{u+N-1}] of N consecutive probe samples and a second array b=[bᵥ, . . . , b_{v+N-1}] of N consecutive response samples, respectively, where u corresponds to the starting index from which samples of a[n·dt] are taken and v is the starting index from which samples of b[n·dt] are taken. The number N is equal to N=G·M, G being a non-zero positive integer. The two arrays of N consecutive samples may be time misaligned, meaning that the starting indexes u and v may have different values.

The data processing unit 7 then provides a measurement of the Rayleigh response of the optical fiber 100 based on the two arrays a=[aᵤ, . . . , a_{u+N-1}] and b=[bᵥ, . . . , b_{v+N-1}] (step 303).

According to an embodiment, at step 303 the measurement of the Rayleigh response is obtained by applying to the two arrays a=[aᵤ, . . . , a_{u+N-1}] and b=[bᵥ, . . . , b_{v+N-1}] a discrete-time Fourier transform (e.g. an FTT, Fast Fourier Transform), thereby obtaining the arrays â=[â₀, . . . , â_{N-1}] and \hat{b}=[\hat{b}₀, . . . , \hat{b}_{N-1}]. The arrays [â=[â₀, . . . , â_{N-1}] and \hat{b}=[\hat{b}₀, . . . , \hat{b}_{N-1}] are then subjected to a point-wise ratio according to the right-hand side of equation [2] above. For this purpose, according to an embodiment, two further arrays â′ and b′ are constructed, respectively from â=[â₀, . . . , â_{N-1}] and \hat{b}=[\hat{b}₀, . . . , \hat{b}_{N-1}]. Firstly, a contiguous subset K′⊆K may be chosen; the first part of â′ is constructed taking (maxK′+1) samples from â, one each G samples, starting from â₀ towards â_{N-1}(e.g. [â₀, â_{G}, â_{2G}, . . . ]). The second part of â′ is constructed taking |minK′| samples, one each G samples, starting â_{N-G}|minK′] towards â_{N-1}. The same procedure is applied to \hat{b}=[\hat{b}₀, . . . , \hat{b}_{N-1}] to obtain the further array \hat{b}′. This way, the arrays â′ and \hat{b}′ basically are restricted to points corresponding to frequency values contained in their discrete frequency-domain support.

Then, an array c is calculated as ĉ=\hat{b}′∅â′ where ∅ stands for Hadamard division. The array ĉ is then subjected to an inverse discrete-time Fourier transform (e.g., an IFFT, Inverse Fast Fourier Transform), thereby obtaining a time-domain Rayleigh response h[m·dt] of |K′| samples, corresponding to the spatial-domain Rayleigh response h[m·dz] of the optical fiber 100. The spatial sampling step dz is equal to dz=Lₘₐₓ/(|K′|−1).

The data processing unit 7 then processes the spatial-domain Rayleigh response h[m·dz] to provide information indicative of the acoustic event to be sensed (step 304). Further details on this step will be provided herein below.

While the data processing unit 7 continuously receives the electrical signals A(t) and B(t) from the optical detectors 4a and 4b and samples them, the measurement of the Rayleigh response as per steps 302-304 may be iterated at discrete time instants, until end of the measurement session (step 305). Such iterations result in a sequence of measurements of the spatial-domain Rayleigh response h[m·dz] equally spaced in time by the iteration period, which basically represents the measurement period δtᵣ. Specifically, a new iteration may be performed by incrementing the values of the starting indexes u and v of the same positive integer amount q≥1, as long as samples of the electrical signals A(t) and B(t) are available. The measurement period δtᵣ is then related to the sampling period dt according to the following equation δtᵣ=δt·q. The lower limit of the measurement period δtᵣ is then δtᵣ=δt, which is obtained when q=1, namely when steps 302-304 are repeated each time a new sample of both the probe electrical signal A(t) and the response electrical signal B(t) is available.

Therefore, the lower limit of the measurement period δtᵣ is substantially independent of the target sensing range Lₘₐₓ.

The target sensing range Lₘₐₓ indeed affects the modulation frequency ƒₘ of the probe light signal, which shall be set such that Lₘₐₓ=c/2ƒₘ. However, as said above, the minimum measurement period δtᵣ of the Rayleigh response is equal to the sampling period dt, which not only is a function of the modulation frequency ƒₘ (and hence of Lₘₐₓ), but is also inversely proportional to the integer number M. Hence, in principle, by setting a suitably high value of M, the lower limit of the measurement period δtᵣ may be arbitrarily reduced. From the practical point of view, this means that the lower limit of the measurement period δtᵣ is substantially due to the processing capabilities of the data processing unit implementing the sampling and the processing of the electrical signals provided by the optical coherent detection of the probe light signal and response light signal.

Herein below, some variants of the interrogator device 200 will be described.

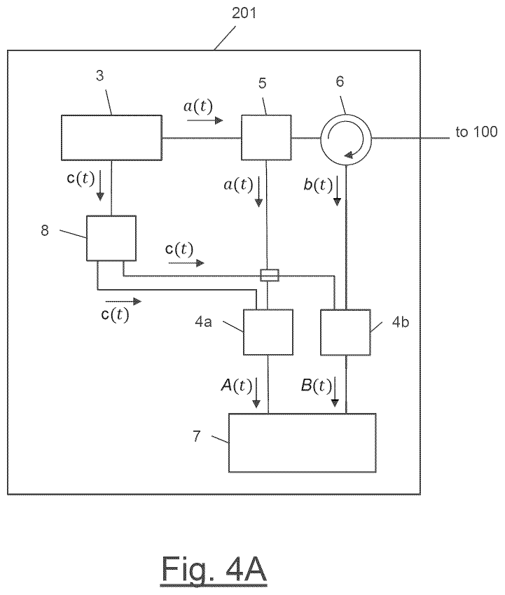

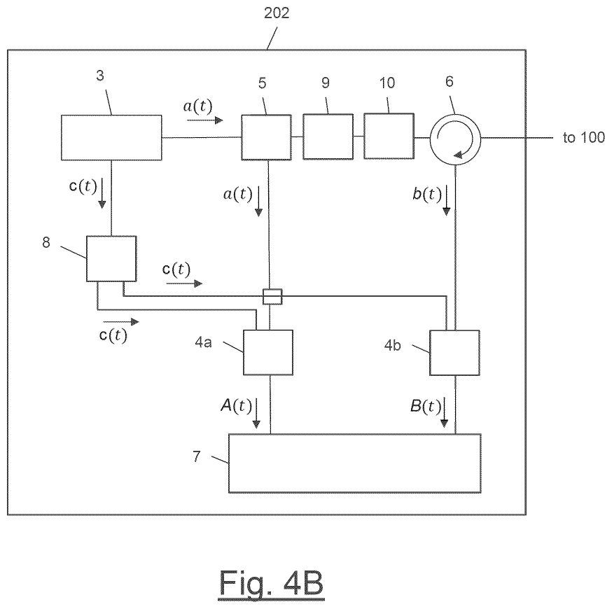

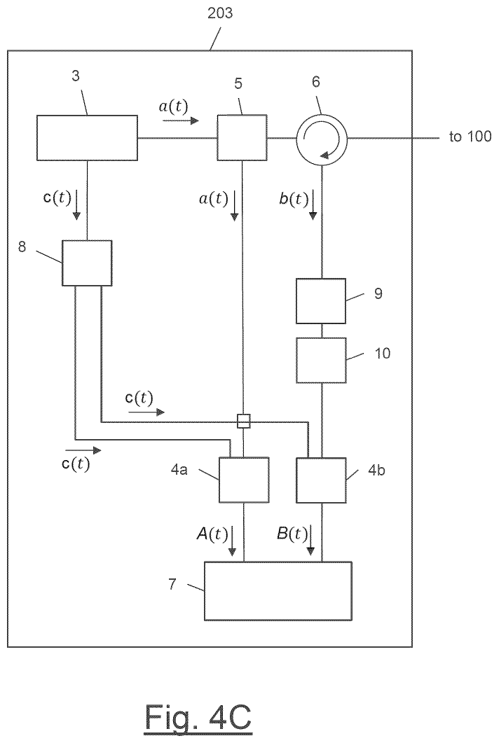

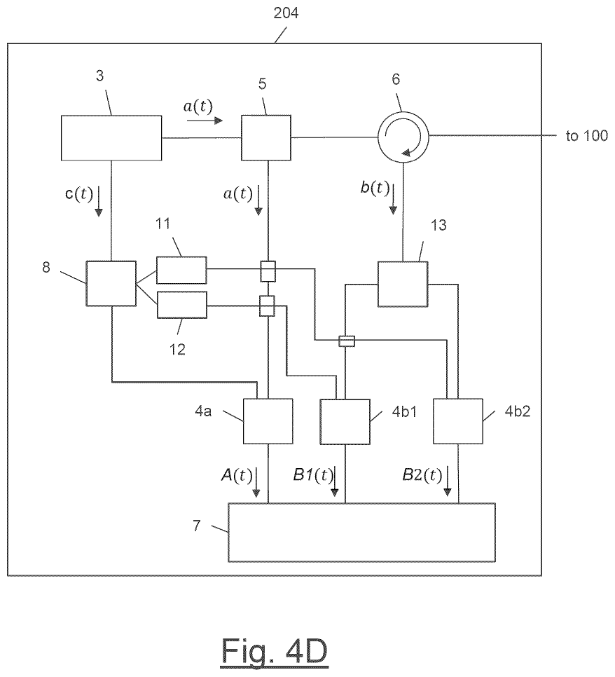

FIG. 4A shows an interrogator device 201 according to a first variant.

According to the first variant, in addition to the probe light signal a(t), the laser source 3 of the interrogator device 201 is also configured to provide an unmodulated light signal c(t). The coherence length of the unmodulated light signal c(t) may be equal to at least 2·Lₘₐₓ. The carrier frequency of the unmodulated light signal c(t) may be selected within a frequency range in which the optical fiber 100 is single mode. The carrier frequency of the unmodulated light signal c(t) may be shifted by a frequency shift ƒᵢₙₜ relative to the carrier frequency of the probe light signal a(t). The frequency shift ƒᵢₙₜ for example is in the RF range and such that ƒᵢₙₜ≥|minK|ƒₘ. The frequency shift can be, for example, in the range 100-500 MHz. According to an embodiment, the probe light signal a(t) and the unmodulated light signal c(t) are emitted through separate outputs of the laser source 3.

According to the first variant, the interrogator device 201 also comprises a further optical splitter 8. The further optical splitter 8 has an input connected to the output of laser source 2 through which the unmodulated light signal c(t) is emitted, and two outputs connected to the optical detectors 4a, 4b. The optical splitter 8 may be a 50:50 optical splitter.

According to the first variant, the optical detectors 4a, 4b use the unmodulated light signal c(t) to perform a heterodyne coherent detection of the light signals a(t) and b(t) respectively, as it will be described in further detail herein below. More specifically, each optical detectors 4a, 4b may comprise an optical coupler 2×2 and a photodiode. The optical coupler 2×2 may be a 50:50 coupler, whose inputs receive the unmodulated light signal c(t) and the light signal a(t) or b(t), respectively, and whose outputs provide the received light signals to the photodiode.

Within each optical detector 4a, 4b, each light signal a(t), b(t) may be heterodyned with the unmodulated light signal c(t). The spectrum of each resulting electrical signal A(t), B(t) has therefore discrete frequency-domain support A′={ω′ₖ=2πƒᵢₙₜ+2πkƒₘ, k∈K⊂ [symbol] }. Such electrical signals are then sampled by the data processing unit 7 as described above, so as to provide the probe sampled signal a[n·dt] and the response sampled signal b[n·dt]. The data processing unit 7 then may subject the sampled signals a[n·dt], b[n·dt] to a digital quadrature demodulation, to provide a baseband representation of such signals, i.e. having discrete frequency-domain support A″={ω″ₖ=2πkƒₘ, k∈K⊂ [symbol] }. The sampled signals a[n·dt], b[n·dt] are then subjected to the processing according to steps 302-304 described above.

FIG. 4B shows an interrogator device 202 according to a second variant.

In addition to the components of the interrogator device 201 according to the first variant, the interrogator device 202 according to the second variant also comprises an optical amplifier 9 interposed between the optical splitter 5 and the optical circulator 6. The optical amplifier 9 increases the optical power of the probe light signal a(t). The optical amplifier 9 may be an Erbium-doped fiber amplifier (EDFA). In some implementations, the optical amplifier 9 may be followed by an optical filter 10, e.g., a bandpass optical filter. The optical amplifier 9 advantageously increases the optical power of the probe light signal a(t) and then allows increasing the target sensing range Lₘₐₓ.of the optical fiber 100.

FIG. 4C shows an interrogator device 203 according to a third variant.

Differently from the interrogator device 202 according to the first variant, in the interrogator device 203 according to the third variant the optical amplifier 9 and the optional optical filter 10 are interposed between the circulator 6 and the optical detector 4b. In this case, the optical amplifier 9 advantageously increases the optical power of the response light signal b(t) before it is received by the optical detector 4b, and then allows increasing the target sensing range Lₘₐₓ.of the optical fiber 100.

FIG. 4D shows an interrogator device 204 according to a fourth variant.

The fourth variant implements a coherent polarization-diversity scheme. Hence, in addition to the components of the interrogator device 201 according to the first variant, the interrogator device 204 according to the fourth variant comprises two polarization controllers 11 and 12 connected to respective outputs of the optical splitter 8. Such polarization controllers 11 and 12 are configured to bring the unmodulated light signal c(t) on respective mutually orthogonal polarizations states. Instead of the optical detector 4b, two optical detectors 4b1 and 4b2 are provided, each one operating on a respective polarization state. Between the circulator 6 and the optical detectors 4b1 and 4b2, a polarization beam splitter 13 is provided, which separates the two polarization states of the response light signal b(t) and provides each one of them to a respective optical detectors 4b1 and 4b2 for separate heterodyne detection, which results into two separate response electrical signals B1(t) and B2(t). Each response electrical signal B1(t) and B2(t) is then separately subjected to the processing according to steps 301-304 of the flow chart of FIG. 3. The processing results in a couple of Rayleigh responses, one per each polarization state. This may be beneficial in providing additional information on the acoustic event to be sensed.

The above variants may be reciprocally combined.

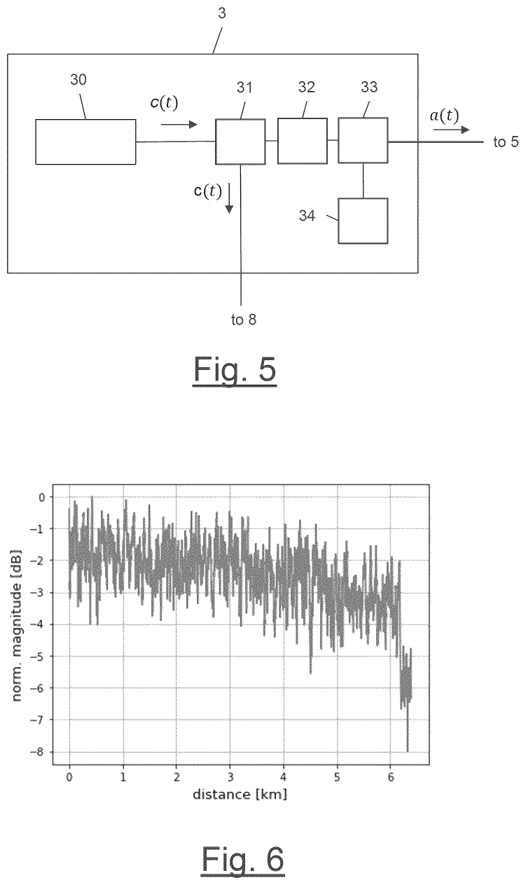

FIG. 5 shows in further detail the laser source 3 comprised in the interrogator device 201, 202, 203, 204.

The laser source 3 for example comprises a CW laser 30, an optical splitter 31, a frequency shifter 32, an optical wave modulator 33 and a RF signal generator 34.

The CW laser 30 for example is configured to emit the unmodulated light signal c(t). The optical frequency of the CW laser 30 may be comprised in the optical C-band, which ranges from 1530 nm to 1565 nm.

The optical splitter 31 has an input connected to the output of the CW laser 30 so as to split the unmodulated light signal c(t) into two portions. The splitting ratio of the optical splitter 31 may be comprised between 85:15 and 95:5, for example 90:10. The optical splitter 31 has two outputs: one output (the one emitting the major part of the unmodulated light signal c(t)) is connected to the frequency shifter 32, while the other output (the one emitting the minor part of the unmodulated light signal c(t)) is connected to the input of the optical splitter 8, which further splits the minor part of the unmodulated light signal c(t) and provides each part to a respective optical detector 4a, 4b, which uses it to perform heterodyne demodulation, as described above.

The frequency shifter 32 is configured to shift the optical frequency of the major part of the unmodulated light signal c(t) by the frequency shift ƒᵢₙₜ.

The optical wave modulator 33 is configured to modulate the output of the frequency shifter 32 with a modulation frequency ƒₘ, so as to provide the probe light signal a(t). As discussed above, the modulation may be applied to one or more of the light signal's quantities, namely amplitude, frequency, and phase.

The Applicant has made some tests using, as optical fiber 100, an optical fiber link of length L≃6.1 km, composed of two connected spools of single mode ITU-T G.652 optical fiber, whose lengths were respectively equal to 4.8 km and 1.3 km.

The graph in FIG. 6 shows the results of a single measurement of the spatial-domain Rayleigh response h[m·dz] obtained by a single iteration of steps 302-304 described above. The following parameters were applied:
ƒₘ=10 kHz, corresponding to Lₘₐₓ≃10.225 km with a group index n_{g}=1.466;
ƒₛ=500 MHz, corresponding to M=50000;
G=2;
X₁=X₂=3M=100000;
u=v=M; and
   |K′|=5393, corresponding to dz≃1.9 m.

In the graph in FIG. 6, the abscissa axis represents the position z along the optical fiber 100, while the ordinate axis represents the normalized magnitude in dB of the spatial-domain Rayleigh response h[m·dz]. In order to reduce the detrimental visual effect of coherent Rayleigh fading, a 20-m-long moving average filter (11 samples) has been applied to the magnitude.

As discussed above, the measurement of the spatial-domain Rayleigh response h[m·dz] may be repeated at discrete time instants, thereby providing a sequence of measurements of the spatial-domain Rayleigh response h[m·dz] equally spaced in time by the measurement period

As mentioned above, the data processing unit 7 processes the spatial-domain Rayleigh response h[m·dz] to provide information indicative of the acoustic event to be sensed (step 304 in the flow chart of FIG. 3).

According to an embodiment, the data processing unit 7 processes the spatial-domain Rayleigh response h[m·dz] by applying a spectral correlation analysis (SCA), which allows identifying a variation of the strain applied to a section Z of the optical fiber 100 between two different times t₁ and t₂. More specifically, the spatial-domain Rayleigh response h[m·dz] is measured at times t₁ and t₂. Then, the two measurements of the spatial-domain Rayleigh responses h[m·dz] are windowed to select only the spatial points pertaining to the section Z, thereby obtaining two arrays h1 and h2. The spectra of the arrays h1 and h2 are then computed and cross-correlated.

According to the spectral shift property of the Rayleigh response, whenever a variation Δϵ≠0 of the applied strain occurs between times t₁ and t₂, the spectral cross-correlation exhibits a peak at a frequency lag Δƒ∝Δϵ≠0. On the other hand, if no variation of the strain occurs between times t₁ and t₂, the spectral cross-correlation exhibits a peak at Δƒ=0. Hence, performing this analysis e.g. over a spatial partition of the whole optical fiber 100 allows to monitor the change of strain in a distributed fashion along the whole length of the optical fiber 100. Furthermore, by continuously extracting the Rayleigh response of the optical fiber 100, such an analysis can be iterated in time, e.g. keeping the time instant t₁ fixed as a reference time and moving the time instant t₂ forward.

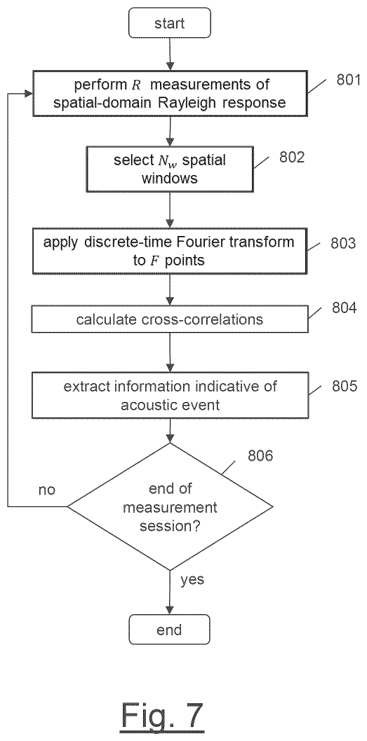

More specifically, with reference to the flow chart of FIG. 7, according to embodiments of the present invention, the data processing unit 7 performs the following processing.

First of all, the data processing unit 7 performs R measurements of the spatial-domain Rayleigh response, by repeating steps 302-304 above R times (step 801). The dataset obtained by the data processing unit 7 at step 801 may be represented as a R×|K′| matrix H=[h_{r,m}], where the first index identifies the measurement time as tᵣ=r q dt and the second index identifies a spatial sample within the spatial-domain Rayleigh response, so that m∈[0, . . . , |K′|−1].

Then, the data processing unit 7 selects N_{w} spatial windows of sample length L_{w} along the second index of H, producing the 3-dimensional data matrix HH=[h_{r,p,w}], where p∈[0, . . . , N_{w}−1] and w∈[0, . . . , L_{w}−1]. In this case, the second index indicates a specific spatial window and is represented by p. Hence, the new third index w identifies a spatial sample within the p^{th} window.

Then, the data processing unit 7 applies a discrete-time Fourier transform to F points (F≥L_{w}) along the third axis of the matrix HH=[h_{r,p,w}], thus providing the matrix [symbol] =[ĥ_{r,p,ƒ}], where ƒ∈[0, . . . , F−1] (step 803).

Then, the data processing unit 7 choses a reference spatial-domain Rayleigh response with index r* and, for each value of the index r other than r and for every value of p, calculates a cross-correlation according to the following equation:

$${{r}^{*} , p}_{} ⋆ {r , p}_{} ( l ) \qquad ( 5 )$$

where [symbol] _{x,y} is the array [ĥ_{x,y,ƒ}∀ƒ∈[0, . . . , F−1]] and * stands for cross-correlation of two discrete sequences with lag l. This operation provides a 3-dimensional data matrix [symbol] =[\hat{x}_{r,p,l}^{r*}] where the superscript r* identifies the reference spatial-domain Rayleigh response and the third subscript l indicates the cross-correlation lag (step 804).

Then, the data processing unit 7 extracts information indicative of the acoustic event to be sensed from [symbol] =[\hat{x}_{r,p,l}^{r*}] , as it will be discussed in further detail herein below (step 805).

Then, the data processing unit 7 reverts to step 801, thereby acquiring a new R′×|K′| dataset H=[h_{r′,m}], r′∈[R, . . . , R+R′−1] to which the processing according to steps 802-805 is applied. The iterations of steps 801-805 thus enable a continuous monitoring of the optical fiber 100, until the end of the measurement session (step 806).

The Applicant has performed some tests of the above procedure for processing the spatial-domain Rayleigh response h[m·dz] to provide information indicative of acoustic events of different types.

A first type of acoustic event considered were impulsive events. Specifically, the system capability to sense two 25-μs-long pulses, spaced by 1.25 ms was tested.

The tested optical fiber 100 was composed by two spools of standard ITU-T G.652 optical fiber, of lengths respectively equal to 4.8 km and 1.3 km, connected through a fiber stretcher.

The following parameters were applied for each single measurement of the spatial-domain Rayleigh response according to the flow chart of FIG. 3:
ƒₘ=10 kHz, corresponding to Lₘₐₓ≃10.225 km with a group index n_{g}=1.466;
ƒₛ=500 MHz, corresponding to M=50000;
G=1;
X₁=X₂=35M=1.75 10⁶;
u=v=M;
   |K′|=5393, corresponding to dz≃1.9 m; and
q=2500, corresponding to ƒᵣ=200 kHz.

As to the spectral correlation analysis of the measurements of the spatial-domain Rayleigh response, the following parameters were applied:
L_{w}=128;
N_{W}=746 windows with a relative shift of 4 samples each;
F=128; and
r*=140.

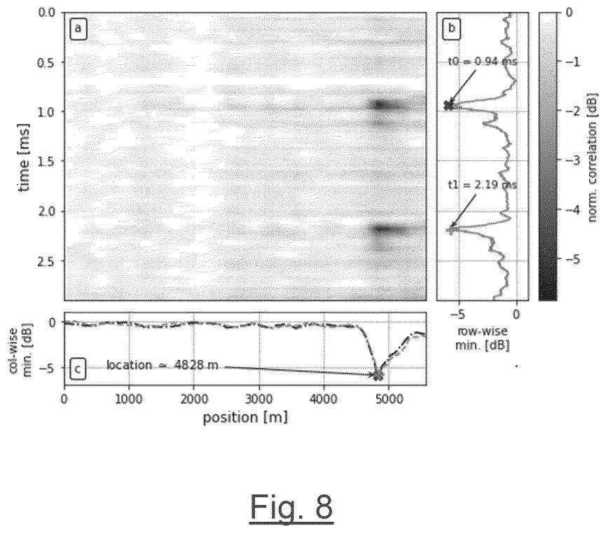

FIG. 8 is a graph which shows the magnitude of the two-dimensional matrix [\hat{x}_{r,p,l=0}^{r*}] , obtained from \hat{X}_{r*}, by fixing the correlation lag l to l=0. The starting coordinate of the spatial window (p, i.e. the distance along the optical fiber 100) is reported on the abscissa axis, time (r) is set forth on the ordinate axis, and the normalized correlation value for lag l=0 is represented through the gray scale. Only windows completely pertaining to the optical fiber 100 have been selected; normalization has been performed with respect to the plane's maximum magnitude.

The time localization of the two acoustic events can be performed by inspecting the row-wise minimum of the plane's magnitude. Such a curve is reported in subplot b of FIG. 8; two time indices r₀ and r₁ (corresponding to times t₀=r₀/ƒᵣ and t₁=r₁/ƒᵣ) are identified as the two local minima, highlighted by the two markers and corresponding to t₀=0.94 ms and t₁=2.19 ms.

The spatial identification of the two acoustic events can be instead performed inspecting the two one-dimensional arrays [\hat{x}_{r=r0,p,l=0}^{r*] and [\hat{x}}_{r=r1,p,l=0}^{r*}], obtained from [symbol] _{r*} by fixing the correlation lag to l=0 and the time index to r=r₀,r₁. The two curves are reported in subplot c of FIG. 8, respectively as dotted-dashed and dashed lines. The location of the acoustic events can be obtained as the global minimum of the two curves, corresponding, in both cases, to z≃4826 m.

It has to be noted that the two acoustic events occurring at the same spatial position along the optical fiber 100 can be detected even if their time distance is not an integer multiple of the measurement period of an equivalent pulse-based RDAS system such as OTDR.

A second type of acoustic event considered were periodic acoustic events, namely vibrations. Specifically, the system capability to sense a vibration having an acoustic frequency of ƒₚ=5100 Hz was tested.

The optical fiber 100 was composed by two spools of standard ITU-T G.652 optical fiber, of lengths respectively equal to 4.8 km and 1.3 km, connected through a fiber stretcher.

The following parameters were applied for each single measurement of the spatial-domain Rayleigh response according to the flow chart of FIG. 3:
ƒₘ=10 kHz, corresponding to Lₘₐₓ≃10.225 km with a group index n_{g}=1.466;
ƒₛ=500 MHz, corresponding to M=50000;
G=1;
X₁=X₂=35M=1.75 10⁶;
u=v=M;
   |K′|=5393, corresponding to dz≃1.9 m; and
q=2500, corresponding to ƒᵣ=200 kHz.

As to the spectral correlation analysis of the measurements of the spatial-domain Rayleigh response, the following parameters were applied:
L_{w}=45;
N_{W}=746 windows with a relative shift of 4 samples each;
F=45; and
r*=140.

In this case, a two-dimensional matrix [\hat{x}_{r,p,l=0}^{r*}] may be obtained from [symbol] _{r*} by fixing the correlation lag l to l=0.

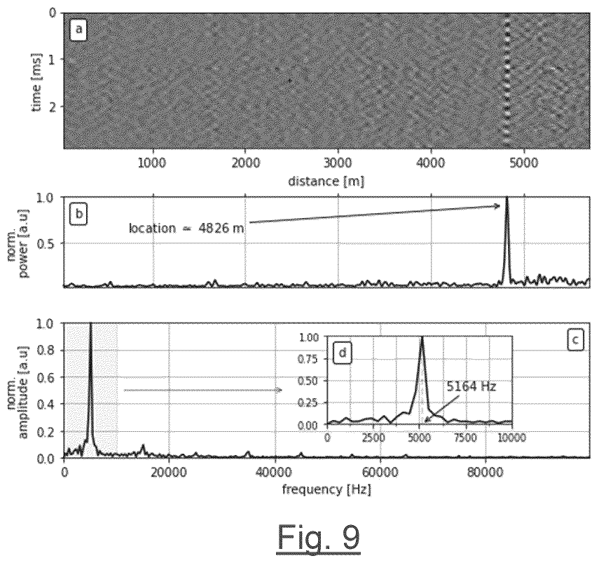

FIG. 9(a) shows the phase difference between the matrixes [\hat{x}_{r,p,l=0}^{r*] and [\hat{x}}_{r,p+P,l=0}^{r*] for P=}6. The starting coordinate of the spatial window (p+P, i.e. the distance along the optical fiber 100) is reported on the abscissa axis, time (r) is reported on the ordinate axis, and the phase of the correlation value for lag l=0 is represented through the gray scale. Only differences between windows completely pertaining to the optical fiber 100 have been selected.

The spatial localization of the vibration can be performed by computing the power of the phase signal along time per each spatial window (i.e. column-wise). The curve obtained is shown in FIG. 9(b), normalized with respect to its own maximum; distance is reported on the x-axis, amplitude on the y-axis. The spatial location of the vibration may be identified as the global maximum of the curve and corresponds to an index p₀+P which in turn represents position z₀≃4826 m within the optical fiber 100.

To determine the frequency of the vibration, the phase of the one-dimensional array [\hat{x}_{r,p=p0+P,l=0}^{r*}] may be extracted and a spectral analysis performed, e.g. through FFT. The obtained magnitude is set forth in FIG. 9(c). In this graph, frequency is reported on the abscissa axis and normalized amplitude on the ordinate axis; normalization is performed with respect to the maximum value. This graph allows to identify the perturbation frequency as \hat{ƒ}ₚ≃5164 Hz, corresponding to the sampled frequency closest to the actual perturbation frequency ƒₚ=5100 Hz. It has to be noted that, with an equivalent known pulse-based RDAS system, the upper limit on the maximum detectable acoustic frequency for the tested distance length Lₘₐₓ≃10.225 km would have been 5000 Hz, assuming group index n_{g}=1.466.

The system 1000 according to the various embodiments of the present invention therefore is advantageous in that it exhibits substantially no deadtime and a measurement period whose lower limit is substantially independent of the target sensing range Lₘₐₓ. It can therefore be used for a variety of applications, including for example:
detecting and localizing acoustic events induced by electric breakdowns in power cables. In this respect, the increased acoustic bandwidth of the system 1000 relative to known interferometric techniques increases the sensitivity of the system and its effectiveness in assisting search and repair of the breakdowns;
detecting time and position of lightning striking along overhead lines;
measuring the spectrum of acoustic events due to underwater leaks in pipelines, thereby facilitating their recognition and classification;
measuring the acoustic waves reflected in geological monitoring, allowing higher frequency sensitivity;
identifying fluid cavitation along pipelines;
measuring vibration modes of overhead lines under wind perturbation, and calculating their mass thereof, this being a measure of accumulated ice; and
measuring vibration spectrum of remote equipment and early detect mechanical degradation from spectrum variation, for example sensitive equipment like pumps in nuclear power plants.

1. A system for Rayleigh-based distributed acoustic sensing of an acoustic event, the system comprising:
an optical fiber;
a laser source configured to inject a probe light signal in the optical fiber, the probe light signal being a light signal periodically modulated with a modulation frequency ƒₘ;
a first optical detector configured to perform a coherent detection of the probe light signal as injected in the optical fiber, thereby providing a probe electrical signal;
a second optical detector configured to perform a coherent detection of a response light signal emitted by the optical fiber in response to the probe light signal undergoing Rayleigh backscattering through the optical fiber, thereby providing a response electrical signal; and
a data processing unit configured to:
sample the probe electrical signal and the response electrical signal with a sampling frequency ƒₛ, thereby providing a probe sampled signal and a response sampled signal, wherein ƒₛ=M ƒₘ, M being a non-zero positive integer;
identify in the probe sampled signal and the response sampled signal, a first array of N consecutive probe samples and a second array of N consecutive response samples, respectively, wherein N=G·M, G being a non-zero positive integer;
provide a Rayleigh response of the optical fiber based on the first array of N consecutive probe samples and the second array of N consecutive response samples; and
obtain information indicative of the acoustic event by processing the Rayleigh response of the optical fiber.

2. The system according to claim 1, wherein:
the laser source is further configured to provide the first optical detector and the second optical detector with an unmodulated light signal, the unmodulated light signal having a carrier frequency shifted relative to a carrier frequency of the probe light signal; and
the first optical detector and second optical detector are configured to perform a heterodyne coherent detection of the probe light signal and the response light signal, respectively, using the unmodulated light signal.

3. The system according to claim 2, further comprising two polarization controllers configured to bring the unmodulated light signal on respective mutually orthogonal polarizations states, and wherein the second optical detector comprises two optical detectors, each one operating on a respective polarization state.

4. The system according to claim 1, further comprising an optical amplifier configured to increase an optical power of the probe light signal before it is injected in the optical fiber.

5. The system according to claim 1, further comprising an optical amplifier configured to increases an optical power of the response light signal before it is received by the second optical detector.

6. The system according to claim 1, wherein the probe light signal is a light signal periodically modulated with non-linear modulation.

7. A method for Rayleigh-based distributed acoustic sensing of an acoustic event, the method comprising:
(a) injecting a probe light signal in an optical fiber, the probe light signal being a light signal periodically modulated with a modulation frequency ƒₘ;
(b) performing a coherent detection of the probe light signal as injected in the optical fiber, thereby providing a probe electrical signal;
(c) performing a coherent detection of a response light signal emitted by the optical fiber in response to the probe light signal undergoing Rayleigh backscattering through the optical fiber, thereby providing a response electrical signal;
(d) sampling the probe electrical signal and the response electrical signal with a sampling frequency ƒₛ, thereby providing a probe sampled signal and a response sampled signal, wherein ƒₛ=M ƒₘ M being a non-zero positive integer;
(e) identifying in the probe sampled signal and the response sampled signal a first array of N consecutive probe samples and a second array of N consecutive response samples, respectively, wherein N=G·M, G being a non-zero positive integer;
(f) providing a Rayleigh response of the optical fiber based on the first array of N consecutive probe samples and the second array of N consecutive response samples; and
(g) obtaining information indicative of the acoustic event by processing the Rayleigh response of the optical fiber.

8. The method according to claim 7, wherein the sampling the probe electrical signal and the response electrical signal comprises sampling the probe electrical signal and the response electrical signal synchronously.

9. The method according to claim 7, wherein the identifying the first array of N consecutive probe samples and the second array of N consecutive response samples comprises identifying the first array of N consecutive probe samples and the second array of N consecutive response samples in a time-misaligned way.

10. The method according to claims 7, wherein the providing the Rayleigh response of the optical fiber based on the first array of N consecutive probe samples and the second array of N consecutive response samples comprises:
applying a discrete-time Fourier transform to the first array of N consecutive probe samples and to the second array of N consecutive response samples, thereby obtaining a third array â=[â₀, . . . , â_{N-1}] and a fourth array \hat{b}=[\hat{b}₀, . . . , \hat{b}_{N-1}], respectively;
subjecting the third arras â=[â₀, . . . , â_{N-1}] and the fourth array \hat{b}=[\hat{b}₀, . . . , \hat{b}_{N-1}] to a point-wise ratio, thereby obtaining a fifth array ĉ; and
applying an inverse discrete-time Fourier transform to the fifth array ĉ.

11. The method according to claim 10, wherein subjecting the third array â=[â₀, . . . , â_{N-1}] and the fourth array \hat{b}=[\hat{b}₀, . . . , \hat{b}_{N-1}] to the point-wise ratio comprises:
constructing first restricted array â′ and second restricted array \hat{b}′ by restricting each one of the third array â=[â₀, . . . , â_{N-1}] and the fourth array \hat{b}=[\hat{b}₀, . . . , \hat{b}_{N-1}] to frequency values contained in their discrete frequency-domain support, respectively; and
obtaining the fifth array ĉ as ĉ=\hat{b}′∅â′, where ∅ stands for Hadamard division.

12. The method according to claim 7, wherein the processing the Rayleigh response of the optical fiber comprises determining a spatial-domain Rayleigh response of the optical fiber and obtaining the information indicative of the acoustic event based on the spatial-domain Rayleigh response.

13. The method according to claim 12, wherein actions (d), (e), (f), and (g) are periodically iterated at discrete time instants, thereby providing a sequence of spatial-domain Rayleigh responses equally spaced in time.

14. The method according to claim 13, further comprising applying a spectral correlation analysis to at least two spatial-domain Rayleigh responses measured at different times.
